(19) United States
(12) Patent Application Publication
(10) Pub. No.: US 2026/0186389 A1
(43) Pub. Date: Jul. 2, 2026

(54) WILDLIFE CAMERA

(71) Applicant: BIRD BUDDY, INC., New York, NY (US)

(72) Inventors: Franci Zidar, New York, NY (US); Julianna Probst, New York, NY (US); Rebeka Vegelj Halb, New York, NY (US); Jeka Neon, New York, NY (US)

(73) Assignee: BIRD BUDDY, INC., New York, NY (US)

(21) Appl. No.: 19/436,165

(22) Filed: Dec. 30, 2025

Related U.S. Application Data
(60) Provisional application No. 63/740,791, filed on Dec. 31, 2024.

(51) Int. Cl. G03B 17/56; G03B 17/08; G06V 20/52; G06V 40/10; H01M 50/24; H04N 23/61; H04N 23/695

(52) U.S. Cl. CPC G03B 17/561; G03B 17/08; G06V 20/52; G06V 40/103; H01M 50/24; H04N 23/61; H04N 23/695; G06V 2201/07

(57) ABSTRACT

A camera assembly is disclosed. The camera assembly includes a weatherproof housing having a power storage device, the weatherproof housing being removably attachable to a mounting element and configured to rotate about a central axis and pivot about a transverse axis with respect to the mounting element; and an image capture system having a camera, a microphone, and a connector configured to removably attach the image capture system to the weatherproof housing and electrically connect the image capture system to the power storage device. A camera system is disclosed. The camera system includes the camera assembly and a control module programmed to identify wildlife responsive to data obtained from the camera and/or the microphone.

### CROSS-REFERENCE TO RELATED APPLICATIONS

This application claims priority under 35 U.S.C. § 119(e) to U.S. Provisional Ser. No. 63/740,791 titled “FLOWER SHAPED CAMERA” filed Dec. 31, 2024, the entire disclosure of which is herein incorporated by reference in its entirety for all purposes.

### FIELD OF TECHNOLOGY

The disclosure relates to camera assemblies for outdoor use. Outdoor cameras may be used to record audio, capture video, and/or images of gardens and wildlife. More specifically, the disclosure relates to modular camera assemblies with a weatherproof housing.

### SUMMARY

In accordance with one aspect, there is provided a camera assembly. The camera assembly may comprise a weatherproof housing comprising a power storage device, the weatherproof housing being removably attachable to a mounting element and configured to rotate about a central axis and pivot about a transverse axis with respect to the mounting element. The camera assembly may comprise an image capture system comprising a camera, a microphone, and a connector configured to removably attach the image capture system to the weatherproof housing and electrically connect the image capture system to the power storage device.

In some embodiments, the connector comprises a magnetic connector.

In some embodiments, the connector comprises a plug-in connector.

In some embodiments, the camera assembly further comprises a swivel configured to rotate the weatherproof housing about the central axis, wherein the weatherproof housing is pivotally coupled to the swivel.

In some embodiments, the mounting element comprises a stem.

In some embodiments, the stem is flexible.

In some embodiments, the stem is rigid.

In some embodiments, the mounting element comprises a clip.

In accordance with another aspect, there is provided a camera system. The camera system may comprise a camera configured to capture images and/or video outdoors. The camera system may comprise a microphone configured to detect sounds near the camera. The camera system may comprise a connector fixed to the camera and the microphone, the connector configured to removably attach the camera and the microphone to a weatherproof housing and electrically connect the camera and the microphone to a power storage device contained within the weatherproof housing. The camera system may comprise a communication element connected to the camera and the microphone and configured to transmit data obtained from the camera and the microphone. The camera system may comprise a control module connected to the communication element, the control module programmed to identify wildlife responsive to the data obtained from the camera and/or the microphone.

In some embodiments, identifying wildlife includes recognizing a genus and species of a subject.

In some embodiments, identifying wildlife further includes recognizing a unique identifier of the subject.

In some embodiments, the control module is programmed to execute a machine-learning model that identifies the wildlife, the machine-learning model trained with historical data and user data.

In some embodiments, the machine-learning model is further trained with universal data.

In some embodiments, the camera system further comprises at least one environmental sensor connected to the communication element.

In some embodiments, the control module is further programmed to identify environmental patterns responsive to the data obtained from the camera and/or the microphone.

In accordance with another aspect, there is provided a kit comprising a weatherproof housing comprising a power storage device. The kit may comprise an image capture system comprising a camera, a microphone, and a communication element connected to the camera and the microphone, the image capture system being removably attachable to the weatherproof housing and electrically connectable to the power storage device. The kit may comprise at least one mounting element, the weatherproof housing being removably attachable to the mounting element. The kit may comprise a control module connectable to the communication element, the control module programmed to identify wildlife responsive to data obtained from the camera and/or the microphone.

In some embodiments, the weatherproof housing is configured to rotate about a central axis and pivot about a transverse axis.

In some embodiments, the mounting element comprises a stem or a clip.

In some embodiments, the kit comprises more than one weatherproof housing, the image capture system being removably attachable to each weatherproof housing wherein the mounting element comprises a clip.

In some embodiments, the kit comprises more than one camera lens configured for use with the camera.

### BRIEF DESCRIPTION OF THE DRAWINGS

Various aspects of at least one embodiment are discussed below with reference to the accompanying figures, which are not intended to be drawn to scale. The figures are included to provide an illustration and a further understanding of the various aspects and embodiments, and are incorporated in and constitute a part of this specification, but are not intended as a definition of the limits of any particular embodiment.

The drawings, together with the remainder of the specification, serve to explain principles and operations of the described and claimed aspects and embodiments. In the figures, each identical or nearly identical component that is illustrated in various figures is represented by a like numeral. For purposes of clarity, not every component may be labeled in every figure. In the figures:

FIG. 1 is a front prospective view of a camera assembly, according to one embodiment;

FIG. 2 is an expanded view of a camera assembly, according to one embodiment;

FIG. 3A is a front perspective view showing a camera within a housing and two interchangeable camera lens, according to one embodiment;

FIG. 3B is an expanded view of a camera within a housing, according to one embodiment;

FIG. 4A is a front view of a stem, according to one embodiment;

FIG. 4B is a front perspective view of a camera assembly, according to one embodiment;

FIG. 5A is a front view of a clip, according to one embodiment;

FIG. 5B is a front perspective view of a camera assembly clipped to a planter, according to one embodiment

FIG. 6A is a front perspective view of a camera assembly with a stem, according to one embodiment;

FIG. 6B is a front perspective view of the camera assembly of FIG. 6A with a clip, according to one embodiment

FIG. 7A is a side view of a camera assembly showing rotation about a transverse axis, according to one embodiment;

FIG. 7B is a side view of the camera assembly of FIG. 7A showing rotation about a central axis, according to one embodiment;

FIG. 7C is a side view of the camera assembly of FIGS. 7A-7B showing rotation about a central axis in another conformation, according to one embodiment;

FIG. 8 is a box diagram of a camera system, according to one embodiment; and

FIG. 9 is a schematic diagram of a camera and housing, according to one embodiment.

### DETAILED DESCRIPTION

Birdwatchers, insect lovers, gardeners, educators, and other enthusiasts enjoy watching and taking pictures of wildlife. However, the close presence of humans may deter birds and insects from approaching a camera, and it is not always possible to take clear pictures of wildlife from afar. Furthermore, enthusiasts may wish to capture video and/or photographs of wildlife in their absence, optionally over an extended period of time. Thus, there is a need for a camera that is capable of remotely taking video and pictures of wildlife without disrupting their natural behavior.

The disclosure relates to a camera assembly that may be used to remotely capture videos and/or photographs of wildlife. The camera assembly may be used to covertly explore and document natural events, such as birds hatching, bee pollination, and the growth of plants. Additionally, the camera assembly may be connectable to an application running on a device, such as a smart phone, tablet, or smart home device, programmed to identify wildlife and/or environmental patterns, and create cinematic footage, optionally through the use of artificial intelligence, and deliver the footage to a user. Use of the camera assembly may encourage awareness, appreciation, enthusiasm, and engagement with nature, as well as promote the preservation of biodiversity.

Disclosed herein is a camera assembly having a waterproof and/or weatherproof housing and a camera positioned within the housing. In some embodiments, the camera is part of an image capture system, which further includes a microphone. The image capture system may also, in certain embodiments, include a communication element connected to the camera and/or microphone and programmed to transmit data obtained by the camera and/or microphone. Thus, in certain embodiments, the footage obtained by the image capture system may be viewed remotely, without physically accessing the camera assembly, and optionally in real time.

Furthermore, in certain embodiments, the camera assembly may be programmed to have certain automatic features that allow remote capture of high quality videos and images. For instance, the camera may be equipped with an autofocus feature that automatically brings a target subject into focus. In certain embodiments, the camera assembly may be programmed to automatically orient the camera in a desired direction upon engagement of the camera with the housing. Additionally, a control module connected to the camera and/or housing may be programmed to allow remote control of the camera, such as zooming in, zooming out, and/or panning in a desired direction.

In certain embodiments, the camera assembly may be suitable for outdoor use. For instance, the camera assembly may be waterproof and/or weatherproof. Waterproof and weatherproof cameras may be constructed to withstand a range of conditions, including precipitation, such as rain, snow, and hail, high winds, and extreme temperatures, such as extreme heat and extreme cold temperatures (for example, at least temperatures between −5° F. to 120° F. (−20° C. to 50° C.)). Thus, in certain embodiments, the materials used to construct the camera assembly may provide a waterproof and/or weatherproof device.

The camera, e.g., image capture system, may be positioned within a waterproof and/or weatherproof housing. In certain embodiments, the camera, e.g., image capture system, may be removably attachable to the housing. For instance, the camera, e.g., image capture system, may easily be attached and removed from the housing, optionally without the use of tools or with the use of minimal tools. The camera, e.g., image capture system, may include a connector that enables removable attachment to the housing.

In certain embodiments, the connector is a magnetic connector. In such embodiments, the housing may include a corresponding magnetic connector positioned to attach to the camera magnetic connector. In other embodiments, the connector is a plug-in connector. The camera and housing may have corresponding plug and socket connectors. For example, the camera may have a plug positioned to correspond with a socket on the housing, or the housing may have a plug positioned to correspond with a socket on the camera.

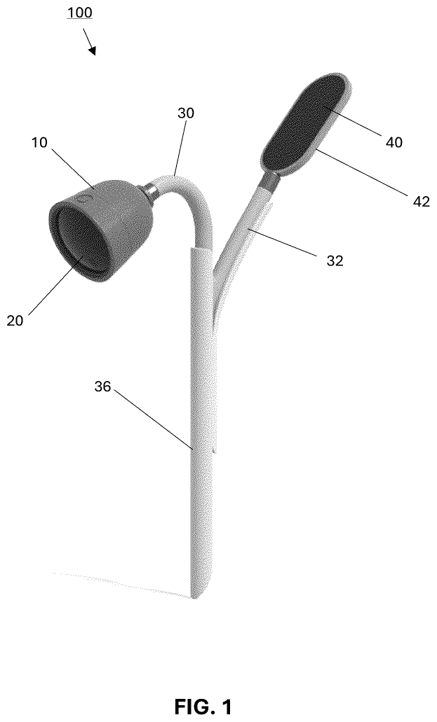

In certain embodiments, the camera assembly may contain features that are designed, e.g., dimensioned and/or pigmented, to resemble natural elements, such as flowers, plants, or other vegetation. One exemplary camera assembly designed to resemble a flower is shown in FIG. 1. The exemplary camera assembly 100 of FIG. 1 is designed, e.g., dimensioned, to resemble a tulip. However, the camera assembly 100 may be designed to resemble any flower, such as a tulip, rose, sunflower, daisy, lily, marigold, daffodil, peony, chrysanthemum, petunia, carnation, hydrangea, or others. In other embodiments, the camera assembly 100 may be designed, e.g., dimensioned, to resemble a non-flowering plant or other vegetation. The design of the camera assembly 100 as a flower or plant may be selected to avoid deterrence of wildlife or to even attract wildlife.

The exemplary camera assembly 100 of FIG. 1 includes a camera 20 positioned within a housing 10. The exemplary housing 10 of FIG. 1 has an outer casing dimensioned to resemble a flower. The housing 10 is shown attached to a stem 30 that includes a branch 32. A solar panel 40 is positioned on a base 42 dimensioned to resemble a leaf. The solar panel 40 and base 42 are shown attached to the branch 32 of the stem 30. A stake 36 dimensioned to resemble a stalk is positioned over part of the stem 30 to allow the stem 30 to be planted into the ground.

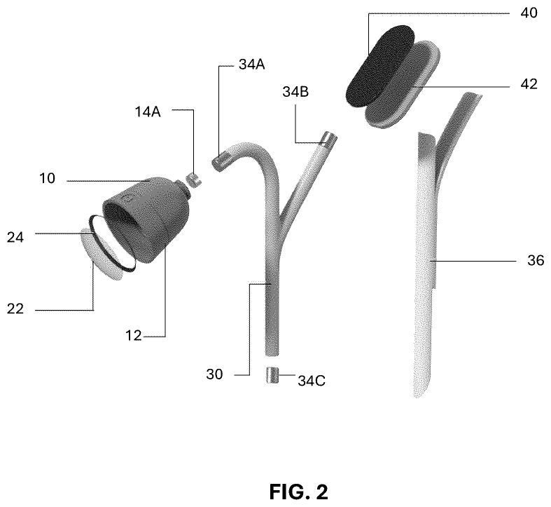

FIG. 2 is an expanded view of exemplary camera assembly 100. As shown in FIG. 2, the camera lens 22 and a lens ring 24 are positioned at an opening of the housing 10. The stem 30 is attached to the housing 10 at a second opening. The exemplary stem 30 includes a branch 32 and magnetic ends 34A, 34B. Magnetic end 34A is shown to be connectable to corresponding magnetic connector 14A on the housing 10. A similar corresponding magnetic connector may be positioned on the solar panel 40 or base 42. Optionally, a magnetic connector may be positioned in the stake 36. The stake 36 is dimensioned to correspond with the stem 30 and is positioned over the stem 30. A pointed end of the stake 36 extends beyond the bottom end of the stem 30.

Thus, in accordance with certain embodiments, there is provided a camera assembly 100 including a camera 20 positioned within a housing 10. The camera 20 may be a standard camera 20. In certain embodiments, the camera 20 may be capable of capturing video with high definition, including up to 2K resolution or up to 4K resolution. The camera 20 may be capable of capturing images with at least 1080 pixels (P), at least 4 megapixels (MP), at least 5 MP, or at least 8 MP with high dynamic range (HDR). The camera 20 may be capable of capturing low light video and images. The camera 20 may be able to capture video with at least 60 frames per second (fps), or at least 120 fps. The camera 20 may be capable of capturing time lapse videos and/or macro recorded videos. In some embodiments, the camera 20 may be used with a wide angle lens. The wide angle lens may be capable of capturing 60°-90°, 90°-120°, 120°-150°, 150°-180°, or 180°+ angle footage. In certain embodiments, the camera 20 may be equipped with an autofocus feature.

In certain embodiments, the camera 20, e.g., an image capture system, may include a microphone or be operably connected to a microphone. The microphone may be positioned within the housing 10 or elsewhere, for example, on or within the stem 30. The capture of footage, such as video footage, may optionally include the capture of associated audio footage. Additionally, the microphone may be capable of detecting and/or capturing audio data independently from video or images.

In some embodiments, the camera 20 and/or microphone may be removably attachable to the housing 10. In such embodiments, the camera 20 and/or microphone may be removed from the housing 10 and positioned within another housing 10, for example, a housing 10 resembling another type of flower, plant, or vegetation, a housing that is another color, etc. Thus, in certain embodiments, more than one interchangeable housing 10 may be used with a camera 20 and/or microphone.

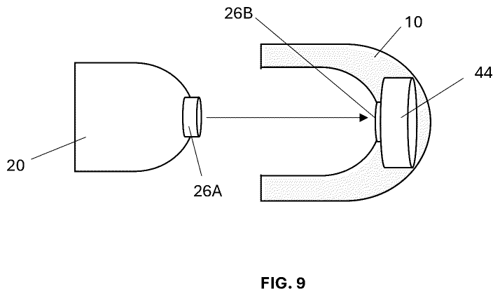

The camera 20, e.g., image capture system, may comprise a connector 26A fixed to the camera 20. The connector 26A may be configured to removably attach the camera 20 and the microphone to the housing 10. In certain embodiments, connection of the camera 20 to the housing 10 may enable automatic orientation of the camera 20 with its surroundings. FIG. 9 includes a cross-sectional view of an exemplary camera 20 and housing 10, including connector 26A and a corresponding connection mechanism 26B on the housing 10.

In other embodiments, the camera 20 and/or microphone may be fixed within the housing 10. In such embodiments, the camera 20 and/or microphone may not easily be removed from the housing 10.

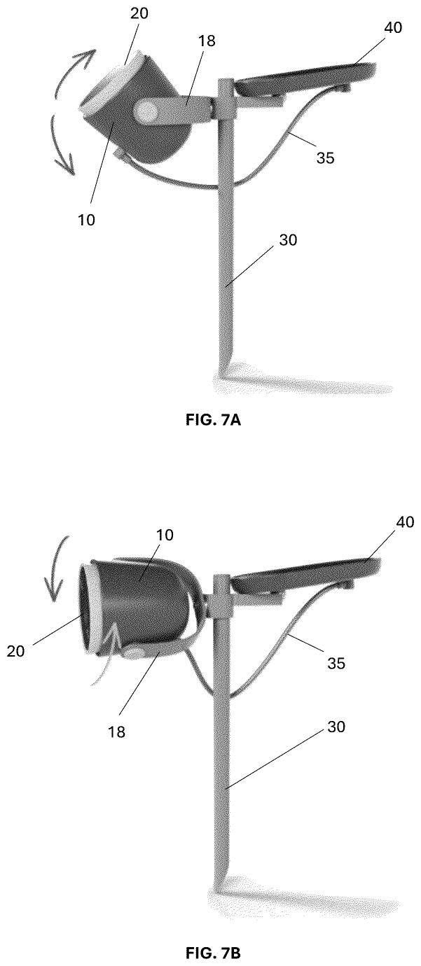

In some embodiments, the housing 10 may be capable of movement in two rotational degrees of freedom. For instance, the housing 10 may be capable of rotation about a central axis and rotation about a transverse axis. The exemplary rotation of the housing 10 is shown in the embodiments of FIGS. 7A-7C. FIG. 7A includes arrows that illustrate rotation about a transverse axis. Rotation about the transverse axis may allow the camera 20 to move up and down, e.g., pivot up and down. FIG. 7B includes arrows that illustrate rotation about a central axis. Rotation about the central axis may allow the camera 20 to rotate clockwise and/or counterclockwise. FIG. 7C includes arrows that illustrate rotation about the central axis in another conformation. Rotation about the central axis and pivoting about the transverse axis may allow the camera 20 to move left and right. As shown in FIGS. 7A-7C, rotation in two degrees of freedom may allow the camera 20 to be pointed in almost every direction.

In some embodiments, as shown in the exemplary embodiments of FIGS. 7A-7C, the housing 10 may comprise a swivel 18. The swivel may be rotationally coupled to the stem 30, to allow rotation about the central axis. The housing 10 may be pivotally coupled to the swivel 18 to allow rotation about the transverse axis. The exemplary housing 10 of FIGS. 7A-7C is shown pivotally coupled to the swivel 18 at a central position. However, the housing 10 may be pivotally coupled to the swivel 18 at any position that allows rotation about the transverse axis.

The housing 10 may be constructed from a durable material, for example, a waterproof and/or weatherproof material. The housing 10 may be constructed from a sustainable material. In certain exemplary embodiments, the housing 10 may be constructed from a durable polymer material. One exemplary polymer material is acrylonitrile butadiene styrene (ABS), optionally an ABS produced without bisphenol A (BPA). Additionally, the material of the housing 10 may be selected to retain vibrancy of colorants and pigments. The colors used in the manufacturing of the housing 10 may be selected to resemble colors found in nature, such as floral colors and greens.

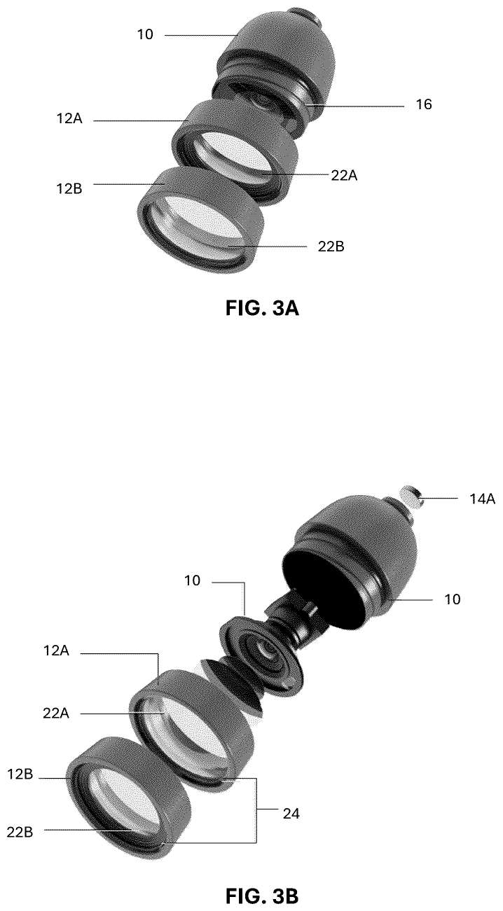

In some embodiments, the housing 10 may comprise a removable lip 12 adjacent the opening for the lens 22 (FIG. 2). The housing 10 may comprise an attachment element 16 designed to correspond with an attachment element of the lip 12. In certain exemplary embodiments, the lip 12 may be removably attachable to the housing 10 by a threaded or bayonet attachment, as shown in FIG. 3A. Other attachment elements may be used. In certain embodiments, the lip 12 and/or housing 10 may comprise a locking mechanism to lock the lip 12 onto the housing 10. A release mechanism may be provided to release the locking mechanism.

In certain embodiments, the lip 12 may be dimensioned to resemble petals. The lip 12 may be dimensioned to resemble petals of a specific flower. For instance, a plurality of lips 12A, 12B may be provided, each dimensioned to resemble petals of a different flower. The more than one lip 12A, 12B may be interchangeable on the housing 10. In such embodiments, each lip 12A, 12B may comprise an attachment element, such as a threaded attachment element, that corresponds with the attachment element 16 of the housing 10.

In some embodiments, the camera lens 22 is removable from the camera 20. More than one lens 22 may be provided, each lens 22 offering a different creative effect. In one exemplary embodiment, a first lens 22A may be a macro lens. Exemplary macro lenses 22A may allow magnification at 2X, 4X, 8X, 10X, 12X or more. A second lens 22B may be a wide-angle lens. Exemplary wide-angle lenses may have 60°-90°, 90°-120°, 120°-150°, 150°-180°, or 180°+ field of vision. Thus, the lenses 22A, 22B may allow for diverse styles like wide-angle landscapes or close-up macro shots. Other lenses may be used, such as lenses that offer varying focal lengths, aperture capabilities, and/or magnification levels. Each lens, e.g., 22A, 22B (or more) may independently be a regular lens, a macro lens, a wide-angle lens, or another type of lens.

In some embodiments, the lens 22 may be attached to a lip 12. A lens ring 24 may be positioned between the lens 22 and the lip 12. The material of the lens ring 24 may be selected to provide a waterproof and/or weatherproof seal for the camera 20. In certain embodiments, the lens ring 24 may be constructed from a flexible elastomeric material. One exemplary flexible elastomeric material is thermoplastic polyurethane (TPU) 60, for example, a shore A TPU 60. Other elastomeric materials may be used.

Thus, in some embodiments, each interchangeable lens 22A, 22B may be attached to a corresponding interchangeable lip 12A, 12B (FIG. 3A). The attachment element of the lip 12 may provide a releasable attachment for ease of removal and replacement of the lens 22 from the camera 20.

FIG. 3B is an exploded view showing the camera 20 components within the housing 10. In the exemplary embodiment shown in FIG. 3B, the camera 20 has a 20 mm diameter. The exemplary housing 10, when assembled, may have a lip 12 diameter of 30-50 mm, e.g., 35-45 mm, or about 38 mm, 40 mm, or 42 mm. The exemplary housing 10, when assembled, may have a length (from the rear opening to the front opening) of 30-50 mm, e.g., 35-45 mm, or about 38 mm, 40 mm, or 42 mm.

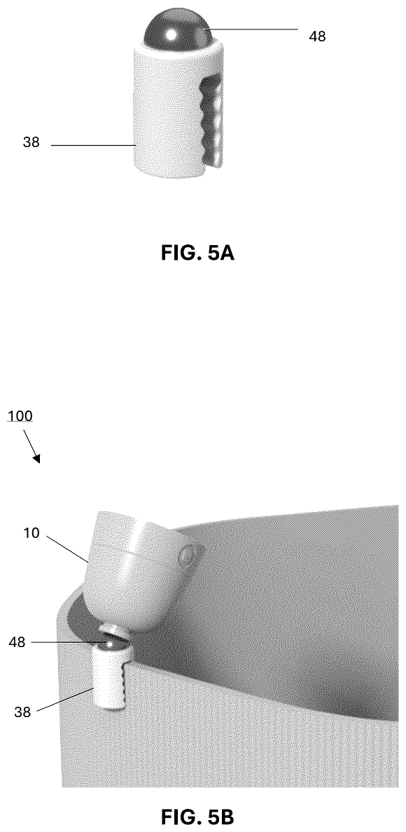

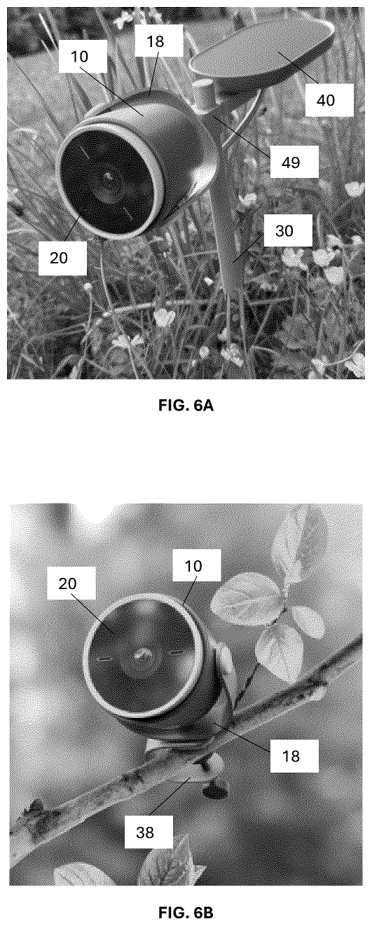

The housing 10 may be removably attachable to a mounting element. The mounting element may allow the camera to be mounted to a variety of structures in an upright position. In certain embodiments, the mounting element may be a stem 30 (FIG. 6A). In certain embodiments, the mounting element may be a clip 38 (FIG. 6B). The housing 10 may comprise a connector configured to attach the housing 10 to the mounting element. In certain embodiments, the connector may be a magnetic connector 14A (FIG. 2). In certain embodiments, the connector may be a plug-in connector. In certain embodiments, the connector may be a ball joint 48 (FIGS. 5A-5B). In certain embodiments, the connector may be a ring, such as ring 49 which is dimensioned to engage stem 30 (FIG. 6A). In certain embodiments, the connector may be a screw. The screw may enable rotational coupling, as shown between swivel 18 and ring 49 (FIG. 6A) and between swivel 18 and clip 38 (FIG. 6B).

The mounting element may be a stem 30. One end of the stem 30 may comprise an attachment point configured to attach to a corresponding attachment point of the housing 10. In some embodiments, the attachment point may form a reversible attachment. In certain embodiments, the stem 30 and/or housing 10 may comprise a locking mechanism to lock the stem 30 onto the housing 10. A release mechanism may be provided to release the locking mechanism.

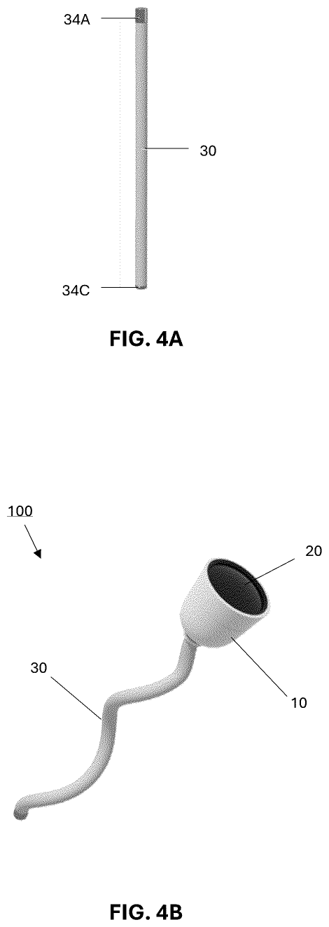

One exemplary stem 30 is shown in FIG. 4A. The stem 30 may comprise one or more magnetic ends 34A, 34C. Magnetic end 34A may be configured to attach to magnetic connector 14A of the housing 10 (FIG. 1). The magnetic ends 34A, 34C, as well as any magnetic connector disclosed herein (such as connector 26A), may be constructed of any material capable of being attracted to a magnet. One exemplary material is stainless steel. Magnetic connector 14A may be constructed of any magnetic material. One exemplary magnetic material is neodymium N45. Additionally, in certain embodiments, the magnetic end 34A and magnetic connector 14A may be reversed. For instance, a strong magnetic material may be positioned on the stem 30 while a material attracted to the strong magnetic material may be positioned on the housing. Furthermore, while the exemplary embodiments show magnetic connectors, it should be understood that other connection mechanisms may be used, for example, threaded or bayonet attachments or others.

In some embodiments, the stem 30 may be flexible. The exemplary stem 30 of FIG. 4B is twisted into loose coils. The stem 30 may be bent into a curved shape to point the camera 20 to a desired angle, for example, as shown in FIG. 1. The stem 30 may be formed of a material that is flexible enough to allow formation into a desired shape, but sturdy enough to hold the desired shape. The stem 30 may be formed of a waterproof and/or weatherproof material. In certain embodiments, the stem 30 may be formed of a sustainable material. One exemplary material is silicone. Other materials may be used.

In some embodiments, the stem 30 may comprise a branch 32 extending from the stem 30 (FIG. 1). A power source may be attached to the stem 30, for example, to the branch 32. In some embodiments, more than one branch 32 may extend from the stem 30, for example, two, three, four, five, six, or more branches 32 may extend from the stem 30. Additional cameras 20 or power sources may be attachable to each branch 32. In some embodiments, the branches 32 may extend in different directions, for example, two branches 32 may extend in opposite directions. In some embodiments, the branches 32 may be curved to extend in a desired direction. By including one or more branches 32, the camera assembly 100 may include two or more cameras 20 positionable to capture views in different directions or different fields of vision. Similarly, by including two or more branches, the camera assembly 100 may include two or more power sources. In other embodiments, the stem 30 is free of any branches (FIG. 6A). The housing 10 and a power source, such as solar panel 40 (if included), may be attached to the single elongated shape of the stem 30.

In some embodiments, the stem 30 and/or the branch 32 may be extendable and/or retractable. For example, the stem 30 and/or the branch 32 may comprise a telescoping extension. The length of the stem 30 and/or branch 32 may be selected by a user. In some embodiments, the stem 30 and/or branch 32 may include a locking mechanism to lock the stem 30 and/or branch 32 at a desired length. A release mechanism may be provided to release the locking mechanism.

It should be noted that while the camera 20 and the power source are shown attachable to the stem 30 at magnetic ends 34A and 34B, respectively, in certain embodiments, the corresponding points of attachment may be universal. For instance, magnetic connector 14A on housing 10 may be connectable to more than one of magnetic ends 34A, 34B, and even 34C. Thus, in certain embodiments, the assembly 100 may be customizable. Each camera 20 and power source may be attachable to any point of attachment on the stem 30.

In certain embodiments, the camera assembly 100 may include a power source. The power source may be electrically connectable to the camera 20. In certain embodiments, the stem 30 may provide an electrical connection between the power source and the camera 20. The attachment point between the housing 10 and the stem 30 may allow power flow to the camera 20. For instance, the magnetic connector 14A and magnetic end 34A may be configured to electrically connect a power source to the camera 20. Additionally, a similar attachment point between the power source and the stem 30 may allow power flow through the stem 30, for example, through magnetic end 34B. In other embodiments, the attachment points may comprise electrical wire connections 35 (FIGS. 7A-7C).

The camera assembly 100 may include any type of power source capable of powering the camera 20. One exemplary power source is a solar panel 40. In some embodiments, the power source may be attached to a base 42 dimensioned to resemble a leaf. The power source may be removably attached to the base 42. In other embodiments, the power source may be fixed to the base 42.

In some embodiments, the camera 20 may comprise or be electrically connected to a power storage device. The power storage device may be a battery, e.g., a rechargeable battery. In some embodiments, the power storage device may be positioned within the housing 10. In some embodiments, the power storage device may be positioned within the stem 30. In some embodiments, the power storage device may be positioned within the power source, for example, within the solar panel 40 or the base 42. The power storage device may be charged by the power source or an external power source. Thus, in certain embodiments, the power storage device may be electrically connectable to the power source. The power storage device may be connectable to an external power source, for example, through a universal connector, such as a USB-C connector. The power storage device may be connectable to the power source, for example, through the stem 30. In certain embodiments, the stem 30 may allow power flow from the power source to the power storage device, directly to the camera 20, or both.

The power storage device may be positioned within the housing 10. One exemplary power storage device is a battery 44 contained within the housing 10. In certain embodiments, the camera 20 and/or microphone may be reversibly electrically connectable to the power storage device 44. Thus, in certain embodiments, the camera 20 and/or microphone may be connected and disconnected from the power storage device 44. For instance, the camera 20 may comprise a connector configured to reversibly electrically connect the camera 20 to the power storage device 44. Optionally, the power storage device 44 may be connectable to a power source, such as solar panel 40.

In certain embodiments, connector 26A, which removably attaches the camera 20 to the housing 10, also electrically connects the camera 20 to the power storage device 44. Thus, a single connector 26A positioned on the camera 20 may allow physical attachment to the housing 10 as well as electrical connection to the power storage device 44 contained within the housing 10. FIG. 9 includes a cross-sectional view of an exemplary camera 20 and housing 10, including connector 26A and corresponding connection mechanism 26B on the housing 10. In the exemplary embodiment of FIG. 9, connector 26A connects the camera 20 to power storage device 44.

In some embodiments, the power storage device may store enough potential to power the camera 20 for several hours, such as overnight, for example, when the solar panel is not capturing energy. In other embodiments, the power storage device may store enough potential to power the camera 20 for several days, weeks, or even months. The power storage device may be connectable to an application running on a smart device, e.g., the power storage device may be connectable to the control module, optionally via the communication element. The application may be programmed to notify a user, optionally in real time, when power storage is low.

In some embodiments, the camera assembly 100 may comprise a stake 36 (FIG. 1). The stake 36 may be dimensioned to resemble the stalk of a flower or plant. The stake 36 may include a pointed end on a bottom surface, which may be used to drive the camera assembly 100 into soil or another soft material, such that the camera assembly 100 is substantially maintained in an upright position for recording and/or capturing images. The stake 36 may be removably attachable to the stem 30, as shown in FIGS. 1-2. The stake 36 may be formed of a durable and/or rigid material. The stake 36 may be formed of a waterproof and/or weatherproof material. In certain embodiments, the stake 36 may be formed of a sustainable material. One exemplary material is powder-coated steel. Other materials may be used. The durable and/or rigid material of the stake 36 may provide stability and protection for the more flexible material of the stem 30, for example, from the elements, weather, wind, physical impact, etc.

In some embodiments, the stake 36 may be extendable and/or retractable. For example, the stake 36 may comprise a telescoping extension. The length of the stake 36 may be selected by a user. In some embodiments, the stake 36 may include a locking mechanism to lock the stake 36 at a desired length. A release mechanism may be provided to release the locking mechanism.

In some embodiments, the stem 30 may be rigid, for example, as shown in FIG. 6A. The rigid stem 30 may allow insertion into the soil. In some embodiments, the rigid stem 30 may have a pointed end on a bottom surface thereof. The stem 30 may be formed of a durable and/or rigid material. The stem 30 may be formed of a waterproof and/or weatherproof material. In certain embodiments, the stem 30 may be formed of a sustainable material. One exemplary material is powder-coated steel. Other materials may be used. The durable and/or rigid material of the stem 30 may provide stability and protection for the camera assembly 100, for example, from the elements, weather, wind, physical impact, etc.

In some embodiments, the mounting element may be a clip 38, as shown in FIG. 5A and FIG. 6B. The clip 38 may have opposing arms dimensioned to grab onto a structure (as shown in FIG. 5B). The clip 38 may have a pressure driver, such as a screw, positioned to tightly fix the clip 38 onto a structure (as shown in FIG. 6B). In some embodiments, an interior surface of the clip 38 may have a textured surface that increases friction against the structure. In some embodiments, one or both of arms of the clip 38 may be pivoting arms. In other embodiments, the arms of the clip 38 may be fixed. The clip 38 may be formed of a durable and sturdy material. The clip 38 may be formed of a waterproof and/or weatherproof material. In certain embodiments, the clip 38 may be formed of a sustainable material. One exemplary material is ABS, e.g., BPA-free ABS. Other materials may be used.

The clip 38 may be attachable to the stem 30 or the housing 10. For instance, the clip 38 may be removably attachable to the stem 30 or the housing 10. The clip 38 is shown attached to the housing 10 in the exemplary embodiments of FIG. 5B and FIG. 6B. The clip 38 may be attachable to the stem 30 at one or each of magnetic ends 34A, 34B, 34C. In some embodiments, the clip 38 may be attachable to the housing 10 at magnetic connection 14A. In other embodiments, the clip 38 may be attachable to the housing 10 at a different attachment point. The clip 38 may be attachable to the swivel 18 (FIG. 6B).

In some embodiments, the clip 38 may comprise a joint 48 which is removably attachable to the stem 30 or the housing 10. Exemplary joint 48 is a ball joint. A ball joint may allow rotation of the housing 10, and thus the camera 20, to a desired angle. Other types of joints may be used, such as a pivot joint, including a single axis and multiple axis pivot joints. In certain embodiments, the joint 48 may be formed of a material capable of being attracted to a magnet, such as magnetic connector 14A. Exemplary materials include stainless steel or steel. Other materials may be used.

In addition to the stake 36 and clip 38, in certain embodiments, the stem 30 may be compatible with other mounting accessories, for use in various environments.

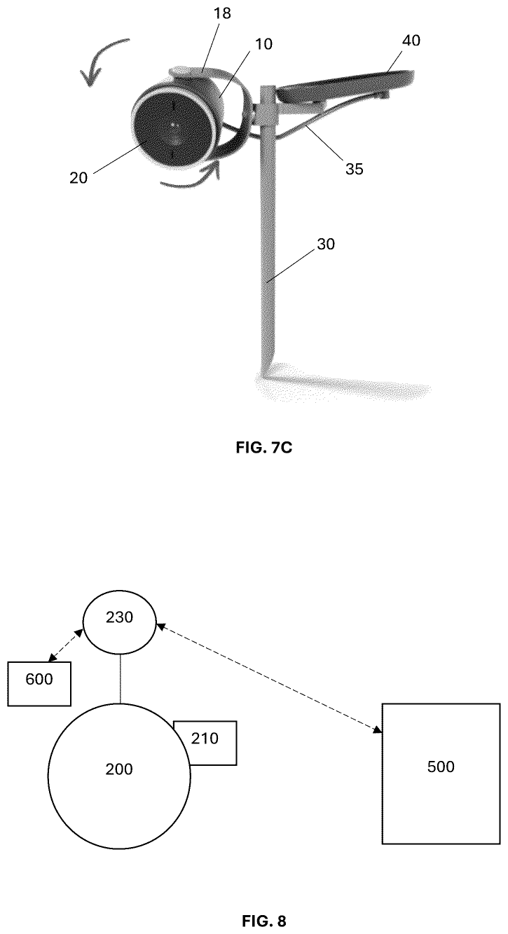

In accordance with one aspect, there is provided a camera system 1000. One exemplary camera system 1000 is shown in FIG. 8. The camera system 1000 may include a camera 200 configured to capture images and/or video outdoors, a microphone 210 configured to detect sounds near the camera, and a control module 500 connected to the camera 200 and microphone 210. In some embodiments, the camera 200 and microphone 210 may be integrally provided in an image capture system, as previously described. A communication element 230 may be connected to the camera 200 and the microphone 210, optionally integrated into an image capture system, and configured to transmit data obtained from the camera 200 and the microphone 210 to the control module 500.

Thus, in certain embodiments, the camera 200 and/or microphone 210, may be connected to a communication element 230. The communication element 230 may be configured to transmit data obtained from the camera 200 and the microphone 210, such as image, video, and/or sound data. In certain embodiments, the communication element 230 may be configured to receive data directed at the camera 200 and the microphone 210, such as instructions for operation and/or software updates. The communication element 230 may be capable of connecting to a network, for example, a wireless local area network or Wi-Fi, a short-range wireless network, or Bluetooth, a cellular or mobile data network, or other, to transmit and/or receive the data.

In certain embodiments, the camera 200 and/or microphone 210 may be connectable to the control module 500. The control module 500 may be in the form of an application running on a smart device, such as a smart phone, tablet, smart home device, or other computing device. The control module 500 may be connected to the communication element 230 and be programmed to receive data transmitted by the communication element 230. The control module 500 may be programmed to process the data received from the communication element 230 and provide information to a user relating to the images, video, and/or sound captured by the image capture system.

In certain embodiments, the control module 500 may be programmed to notify a user, optionally in real time, of information relating to the data obtained by the camera 200 and/or microphone 210. For instance, the control module 500 may be programmed to notify a user when certain triggers are detected, such as the presence of motion within a target field of view of the camera 200 and/or audio detected by the microphone 210. The control module 500 may be programmed to set the camera 200 to capture video or capture images automatically responsive to a predetermined trigger.

In certain embodiments, the camera 200, e.g., image capture system, may be capable of edge computing. The camera 200, e.g., image capture system, may be capable of performing certain actions responsive to instructions for operation received from a user through the application, e.g., control module 500, such as zoom in, zoom out, capture audio, capture video, and/or capture photographs. In certain embodiments, the camera 200, e.g., image capture system, may be programmable to capture audio, capture video, and/or capture images on a specific schedule, for example, at certain times of the day, days of the week, days of the month, etc. In some embodiments, a user may be able to program the schedule. In some embodiments, the camera 200, e.g., image capture system, may be capable of capturing audio and/or capturing video substantially continuously over an extended period of time. For instance, the camera 200 may be useable to record time-lapse videos.

In certain embodiments, the control module 500 may be programmed to automatically detect and analyze the captured images, video, and/or audio data. For instance, the control module 500 may be programmed to extract and identify predetermined features from the captured images, video, and/or audio. In certain embodiments, the control module 500 may be programmed to identify wildlife responsive to the data obtained from the camera 200 and/or the microphone 210. Identifying wildlife may include recognizing a genus and species of a subject. Identifying wildlife may include recognizing a variation of a subject, such as a subspecies, breed, population, lineage, strain, variety, type, colorway, pattern, etc. In certain embodiments, identifying wildlife may further include recognizing a unique identifier of the subject, such as identifying a subject by name, serial number, or other unique identifier.

As used herein, a “subject” may include an animal, a mammal, a bird, a reptile, an amphibian, a fish, an invertebrate, e.g., arthropod, e.g., insect, arachnid, crustacean, and/or myriapod, a plant, or a human. In some embodiments, he term “subject” is intended to include human and non-human animals, for example, birds, mammals, small animals, pollinators, arthropods, and terrestrial animals. In some embodiments, the term “subject” is intended to include plants, for example, non-vascular plants, vascular plants, seed plants, trees, shrubs, herbs, vines, and grasses, and plant parts, for example, leaves, flowers or buds, stems, seeds, trunks, branches, roots, etc.

The control module 500 may be programmed to notify a user, optionally in real time, of the identified wildlife and/or provide informative or educational content responsive to the identified subjects. The informative or educational content may comprise information such as relevant biological, historical, geographical, and other facts, care and/or support tips and instructions, and others. The predetermined features may be correlated to a natural event, type or species of animal or plant, identity of an animal, or other aspect of interest. For example,

In certain embodiments, the control module 500 may be programmed to identify and track events, such as weather events and predictions, birds hatching, bee pollination, squirrel feeding, or others. The control module 500 may be programmed to identify health status of plants and/or animals and provide care instructions for health concerns related to the subjects, such as overwatering, underwatering, injuries, infestations, pests, or others. The control module 500 may be programmed to identify types or species of subjects, e.g., birds, insects, plants, or other animals. The control module 500 may be programmed to track specific subjects, e.g., birds, insects, or other animals and identify a frequency of their visit to the location of the system as well as a number of individual subjects, e.g., birds, insects, or other animals over time. The control module 500 may be programmed to identify and track environmental patters, such as weather events (e.g., precipitation, lack of precipitation, temperature, humidity, wind, air pressure, etc.), solar and/or lunar patterns, visibility, air quality, solar radiation intensity, e.g., UV exposure, flood or drought cycles, water level fluctuations, heat distribution, and/or soil and ground patterns, e.g., soil moisture, nutrient levels, ground temperature, etc.

In some embodiments, the computer system 1000 may include one or more environmental sensor 600. The environmental sensor 600 may be connected to the communication element 230, such that the communication element 230 may be configured to transmit data obtained by the environmental sensor 600. The communication element 230 may also be configured to transmit data to the environmental sensor 600, such as operating instructions and/or software updates. The environmental sensor 600 may be configured to collect environmental data in the vicinity of the camera 200, e.g., image capture system. In some embodiments, the environmental sensor 600 may include a temperature sensor, a humidity sensor, a light sensor, a wind sensor, an air quality sensor, etc. The control module 500 may be programmed to identify and track environmental patterns responsive, at least in part, to data obtained from the environmental sensor 600.

In some embodiments, this data may be stored on a memory storage device associated with the camera 200, e.g., image capture system, and/or control module 500. The memory storage device may be a local, remote, or cloud-based memory storage device. The control module 500 and/or camera 200, e.g., image capture system, may utilize historical data and implement machine learning to improve the identification of natural events, types or species of subjects, e.g., animals or plants, identity of subjects, or others over time. The control module 500 and/or camera 200, e.g., image capture system, may optionally also utilize user data and/or universal data to improve its data analysis and recognition models.

In certain embodiments, the control module 500 may run an artificial intelligence platform programmed to perform such tasks. For instance, the control module 500 may be programmed to execute a machine-learning model that processes the data obtained from the camera 200 and/or microphone 210 to make recognitions, such as identifying the wildlife, identifying the health status of the wildlife, and/or identifying environmental patterns. The machine-learning model may be trained with historical data. Historical data may include a collection of past data used to train, validate, test, and/or refine the machine-learning model. In some embodiments, the machine-learning model may further be trained with user data. User data may include data collected by the user during use of the particular camera system, optionally a plurality of camera systems used by the particular user. In some embodiments, the machine-learning model may further be trained with universal data. Universal data may include user data collected by a plurality of users of similar camera systems, optionally all users.

In certain embodiments, the control module 500 and/or camera 200, e.g., image capture system, may be programmed to automatically process and/or edit captured footage, e.g., audio, video, and/or images, and produce high quality visual and/or audio content from the captured data. For instance, the control module 500 and/or camera 210, e.g., image capture system, may be programmed to process captured footage with the purpose of decreasing time delay for user experience, saving bandwidth on information transfer, and/or lowering computational needs.

In accordance with another aspect, there is provided a kit comprising a camera 20 and at least one housing 10. In some embodiments, the kit may include more than one housing 10, for example, in embodiments in which the camera 20 is removable from the housing 10. The camera 20 may be removably attachable to each housing 10. In certain embodiments, the kit may include more than one camera 20. The housing 10 may be capable of receiving each camera 20. In certain embodiments, each housing 10 contained in the kit may be dimensioned to resemble a different flower, plant, or vegetation. In certain embodiments, each housing 10 may be a different color.

The kit may include at least one interchangeable lens 22. In some embodiments, the kit may include more than one interchangeable lens 22. For example, the kit may include a macro lens 22A and a wide angle lens 22B. Each interchangeable lens 22 may be configured for use with the camera 20.

The kit may include at least one interchangeable lip 12 of the housing. In some embodiments, the kit may include more than one interchangeable lip 12. For example, in certain embodiments, each lip 12 may be dimensioned to resemble petals of a different flower, or a different plant or vegetation. In certain embodiments, each lip 12 may be a different color.

In some embodiments, each of the interchangeable lens 22 may be attached to a corresponding interchangeable lip 12.

The kit may include at least one mounting element. For example, the kit may include a stem 30 removably attachable to the housing 10. In certain embodiments, the kit may include a flexible stem 30 (FIG. 4B). In certain embodiments, the kit may include a rigid stem 30 (FIG. 6A). In certain embodiments, the kit may include a flexible stem 30 and a rigid stem 30. In some embodiments, the kit may include a clip 38 (FIG. 6B).

In some embodiments, the kit may further include at least one power source removably attachable to the stem 30. The power source may be electrically connectable to the camera 20. In some embodiments, at least one power source may comprise a solar panel.

In some embodiments, the kit may further include at least one power storage device electrically connectable to the camera 20 and, optionally, a charging cable for the at least one power storage device. In some embodiments, the power storage device may be electrically connectable to the at least one power source. In certain embodiments, the power storage device may be contained within the housing 10.

The kit may include a stake 36 removably attachable to the stem 30.

In some embodiments, the kit may comprise instructions for assembly of the components into a camera assembly 100.

The disclosure is not limited in its application to the details of construction and the arrangement of components set forth in the following description or illustrated in the drawings. The disclosure is capable of other examples and of being practiced or of being carried out in various ways. Also, the phraseology and terminology used herein is for the purpose of description and should not be regarded as limiting. The use of “including,” “comprising,” “having,” “containing,” “involving,” and variations thereof herein is meant to encompass the items listed thereafter and equivalents thereof as well as additional terms.

Having thus described several aspects of at least one embodiment of this disclosure, it is to be appreciated that various alterations, modifications, and improvements will readily occur to those skilled in the art. Such alterations, modifications, and improvements are intended to be part of this disclosure and are intended to be within the spirit and scope of the disclosure. Accordingly, the foregoing description and drawings are by way of example only.

What is claimed is:

1. A camera assembly comprising:
a weatherproof housing comprising a power storage device, the weatherproof housing being removably attachable to a mounting element and configured to rotate about a central axis and pivot about a transverse axis with respect to the mounting element; and
an image capture system comprising a camera, a microphone, and a connector configured to removably attach the image capture system to the weatherproof housing and electrically connect the image capture system to the power storage device.

2. The camera assembly of claim 1, wherein the connector comprises a magnetic connector.

3. The camera assembly of claim 1, wherein the connector comprises a plug-in connector.

4. The camera assembly of claim 1, further comprising a swivel configured to rotate the weatherproof housing about the central axis, wherein the weatherproof housing is pivotally coupled to the swivel.

5. The camera assembly of claim 4, wherein the mounting element comprises a stem.

6. The camera assembly of claim 5, wherein the stem is flexible.

7. The camera assembly of claim 5, wherein the stem is rigid.

8. The camera assembly of claim 1, wherein the mounting element comprises a clip.

9. A camera system comprising:
a camera configured to capture images and/or video outdoors;
a microphone configured to detect sounds near the camera;
a connector fixed to the camera and the microphone, the connector configured to removably attach the camera and the microphone to a weatherproof housing and electrically connect the camera and the microphone to a power storage device contained within the weatherproof housing;
a communication element connected to the camera and the microphone and configured to transmit data obtained from the camera and the microphone; and
a control module connected to the communication element, the control module programmed to identify wildlife responsive to the data obtained from the camera and/or the microphone.

10. The camera system of claim 9, wherein identifying wildlife includes recognizing a genus and species of a subject.

11. The camera system of claim 10, wherein identifying wildlife further includes recognizing a unique identifier of the subject.

12. The camera system of claim 9, wherein the control module is programmed to execute a machine-learning model that identifies the wildlife, the machine-learning model trained with historical data and user data.

13. The camera system of claim 12, wherein the machine-learning model is further trained with universal data.

14. The camera system of claim 9, further comprising at least one environmental sensor connected to the communication element.

15. The camera system of claim 9, wherein the control module is further programmed to identify environmental patterns responsive to the data obtained from the camera and/or the microphone.

16. A kit comprising:
a weatherproof housing comprising a power storage device;
an image capture system comprising a camera, a microphone, and a communication element connected to the camera and the microphone, the image capture system being removably attachable to the weatherproof housing and electrically connectable to the power storage device;
at least one mounting element, the weatherproof housing being removably attachable to the mounting element; and
a control module connectable to the communication element, the control module programmed to identify wildlife responsive to data obtained from the camera and/or the microphone.

17. The kit of claim 16, wherein the weatherproof housing is configured to rotate about a central axis and pivot about a transverse axis.

18. The kit of claim 16, wherein the mounting element comprises a stem or a clip.

19. The kit of claim 16, comprising more than one weatherproof housing, the image capture system being removably attachable to each weatherproof housing.

20. The kit of claim 16, comprising more than one camera lens configured for use with the camera.
